(19) United States
(12) Patent Application Publication
(10) Pub. No.: US 2015/0175205 A1
(43) Pub. Date: Jun. 25, 2015

(54) METHOD FOR SELECTING THE AUTOMATIC PARKING MODE USING A STEERING WHEEL

(71) Applicant: HYUNDAI MOTOR COMPANY, Seoul (KR)

(72) Inventors: Jin-Ho PARK, Hwasung-shi (KR); Young-Bin KIM, Seoul (KR); Joo-Woong YANG, Anyang-shi (KR); Kyung-Soo HA, Pohang-shi (KR); Gil-Won SEO, Hwasung-shi (KR)

(21) Appl. No.: 14/522,213

(22) Filed: Oct. 23, 2014

(30) Foreign Application Priority Data
Dec. 2, 2013 (KR) 10-2013-148676

(51) Int. Cl. B62D 15/02; B60W 30/06

(52) U.S. Cl. CPC B62D 15/0285; B60W 30/06; B60W 2710/20; B60W 2710/1094

(57) ABSTRACT

A method for selecting an automatic parking mode of a vehicle includes receiving whether the automatic parking mode is perpendicular parking or parallel parking. The automatic parking mode is selected by turning a steering wheel in a clockwise or counterclockwise direction according to a steering wheel angle as displayed on a human machine interface (HMI) in accordance with the received perpendicular parking or parallel parking.

### CROSS-REFERENCE TO RELATED APPLICATION

This application claims under 35 U.S.C. §119(a) the benefit of priority to Korean Patent Application No. 10-2013-148676 filed on Dec. 2, 2013, the entire contents of which are incorporated herein by reference.

### TECHNICAL FIELD

The present disclosure relates to a method for selecting an automatic parking mode of a vehicle, and more particularly, to a method for selecting an automatic parking mode which selects an automatic parking mode by receiving information whether the automatic parking mode is perpendicular parking or parallel parking through a parking mode switch and by turning a steering wheel in a direction displayed on a user control screen in accordance with the received perpendicular parking or parallel parking information.

### BACKGROUND

Recently, an automatic parking system, which is generally called a smart parking assist (SPAS), automatically park a vehicle by assisting drivers has been developed.

As shown in FIG. 1, the automatic parking system senses a space where a vehicle is parked and a distance to the space in a parking area by using a plurality of ultrasonic sensors 10b, 10c, 10d, and 10e on a front side of a car body, ultrasonic sensors 10a and 10f on right and left sides of the front of the car body, a plurality of ultrasonic sensors 20b, 20c, 20d, and 20e on a rear side of the car body, and ultrasonic sensors 20a and 20f on right and left sides of the rear of the car body. The automatic parking system monitors a steering angle that is the degree of turn of the vehicle by using a steering angle sensor (SAS) 30 provided in the vehicle, and then a smart parking assist system electronic control unit (SPAS ECU) 60 calculates a moving direction and the steering angle of the vehicle in accordance with a steering logic for automatic parking in response to signals from the ultrasonic sensors 10a-10f and 20a-20f and the steering angle sensor 30.

The moving direction and the steering angle of the vehicle calculated by the SPAS ECU 60 are displayed on a human machine interface (HMI) provided in the vehicle, and a driver drives the vehicle to the parking area by operating a steering wheel and a brake in accordance with information displayed on the HMI. In this process, a motor driven power steering (MDPS) of the vehicle also operates, thereby steering the vehicle.

A method of selecting a parking mode by a driver by pressing a parking mode switch (not shown) on a dashboard in front of a driver to automatically park a vehicle has been used in the related art, however, the operation is complicated in this process.

In detail, the parking mode is changed each time the driver presses the parking mode switch, and the parking mode will be described hereinbelow.

There are a rearward-perpendicular right parking mode for rearward-perpendicular parking with the parking area at a right side of the vehicle, a rearward-perpendicular left parking mode for rearward-perpendicular parking with the parking area at a left side of the vehicle, a rearward-parallel right parking mode for rearward-parallel parking with the parking area at the right side of the vehicle, and a rearward-parallel left parking mode for rearward-parallel parking with the parking area at the left side of the vehicle. Here the driver has to manually change and select the parking mode by pressing the parking mode switch several times in order to select a desired parking mode. If more parking modes, such as a forward-perpendicular right parking mode for forward-perpendicular parking with the parking area at the right side of the vehicle, and a forward-perpendicular left parking mode for forward-perpendicular parking with the parking area at the left side of the vehicle, are added, selecting the desired parking mode become more complicated, so the driver may feel more inconvenient.

According to the automatic parking method of the related art, the driver has to select any one of the parking modes before searching for the parking area with the ultrasonic sensors, so when parking in a different parking area from the selected mode, the driver has to start searching for the parking area again with the ultrasonic sensors after stopping the automatic parking system.

The description provided above as a related art of the present invention is just for helping in understanding the background of the present invention and should not be construed as being included in the related art known by those skilled in the art.

### SUMMARY

The present disclosure has been made in an effort to provide a method of selecting an automatic parking mode using a steering wheel which enables a driver to easily select the mode for automatic parking and to select the mode and a direction through a simple operation after searching a parking area.

In a method of selecting an automatic parking mode of a vehicle according to an exemplary embodiment of the present disclosure, whether an automatic parking mode is perpendicular parking or parallel parking is received. The automatic parking mode is selected by turning a steering wheel in a clockwise or counterclockwise direction according to a steering wheel angle as displayed on a human machine interface (HMI) in accordance with the received perpendicular parking or parallel parking.

According to the method for selecting the automatic parking mode of a vehicle, since a driver can simply select the automatic parking mode by turning the steering wheel left or right at a predetermined angle in order to select the mode for automatic parking, there is no need to press a parking mode switch several times as in the related art.

Further, since it is possible to select the automatic parking mode even after searching for a different parking area, user convenience is improved.

### BRIEF DESCRIPTION OF THE DRAWINGS

The above and other features of the present disclosure will now be described in detail with reference to certain exemplary embodiments thereof illustrated by the accompanying drawings which are given hereinbelow by way of illustration only, and thus are not limitative of the present disclosure.

FIG. 1 is a diagram showing a configuration of a typical system for automatic parking.

FIGS. 2 and 3 are views showing an example of a human machine interface according to a method for selecting an automatic parking mode, in which FIG. 2 shows an example of a control screen for selecting a perpendicular parking mode and FIG. 3 is an example of a control screen for selecting a parallel parking mode.

FIG. 4 is a flowchart of automatic parking according to the method for selecting an automatic parking mode of the present disclosure.

FIG. 5 is a view showing a vehicle that is parked in accordance with the method for selecting an automatic parking mode of the present disclosure.

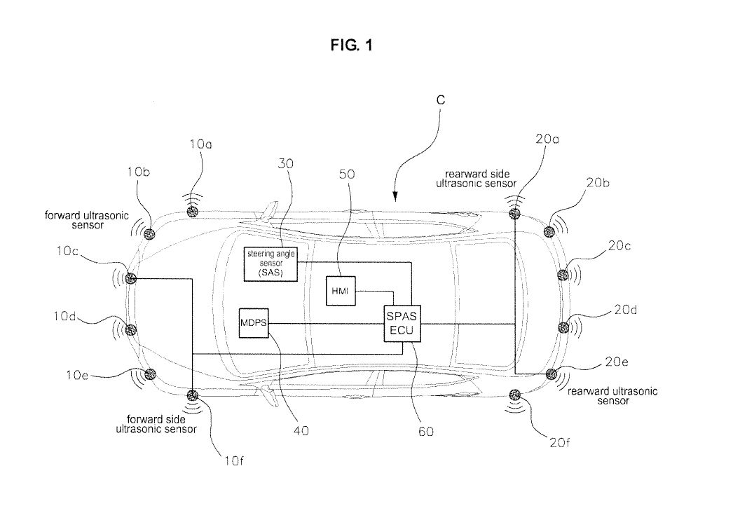

It should be understood that the appended drawings are not necessarily to scale, presenting a somewhat simplified representation of various features illustrative of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, a method for selecting an automatic parking mode using a steering wheel of the present disclosure is described in detail with reference to the drawings.

However, the drawings are provided as an example for those skilled in the art to be able to more clearly understand the spirit of the present invention. Accordingly, the present invention is not limited to the drawings and may be achieved in other ways.

Further, if not stated, the terms used herein have the meanings generally understood by those skilled in the art, and functions and configurations known in the art which may make the subject matter of the present invention unclear are not described and shown in the drawings.

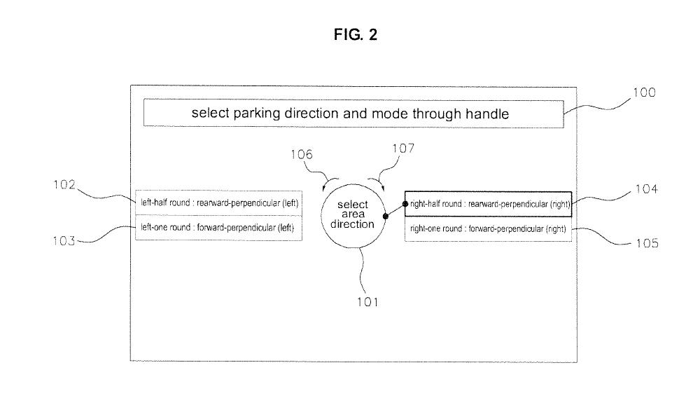

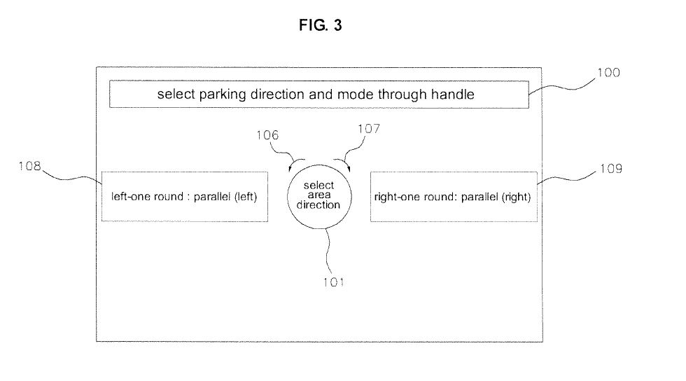

FIGS. 2 and 3 are views showing an example of a human machine interface according to a method for selecting an automatic parking mode, in which FIG. 2 shows an example of a control screen for selecting a perpendicular parking mode and FIG. 3 is an example of a control screen for selecting a parallel parking mode.

According to the method of selecting an automatic parking mode of the present disclosure, whether it is perpendicular parking or parallel parking is selected through a parking mode switch (not shown) and a steering wheel is turned by an angle displayed on a human machine interface 50 in accordance with the selected perpendicular parking or parallel parking, thereby each automatic parking mode is selected.

That is, as shown in FIG. 2, when a driver selects the perpendicular parking of the automatic parking modes through the parking mode switch, a message window 100 saying “select a parking direction and a parking mode by operating the steering wheel” is displayed on the human machine interface 50. A parking direction display section 101 having a circular shape for selecting whether a parking area is at a left or right side of the vehicle is displayed at a center of the human machine interface 50. A left steering arrow 106 showing left turn of the steering wheel and a right steering arrow 107 showing right turn of the steering wheel are displayed above the parking direction display section 101.

A rearward-perpendicular left parking mode selecting section 102 and a forward-perpendicular left parking mode selecting section 103 are displayed at a left side of the parking direction display section 101.

In the rearward-perpendicular left parking mode selecting section 102, it is displayed that the parking mode is a rearward parking mode, and a direction to the parking area is the left of the vehicle, and the turning amount of the steering wheel for selecting the rearward-perpendicular left parking mode is also displayed. The turning amount of the steering wheel shown in FIG. 2 is a left-half round as an example and a range of the turning amount can be appropriately changed.

In the forward-perpendicular left parking mode selecting section 103, it is displayed that the parking mode is the forward parking mode and the direction to the parking area is the left of the vehicle, in which the turning amount of the steering wheel for selecting the forward-perpendicular left parking mode is left-one round in FIG. 2 as an example. The range of the turning amount can be appropriately changed, as described above.

A rearward-perpendicular right parking mode selecting section 104 and a forward-perpendicular right parking mode selecting section 105 are displayed at a right side of the parking direction display section 101.

In the rearward-perpendicular right parking mode selecting section 104, it is displayed that the parking mode is a rearward parking mode, and the direction to the parking area is the right of the vehicle. The turning amount of the steering wheel for selecting the rearward-perpendicular right parking mode is also displayed as a right-half round.

In the forward-perpendicular right parking mode selecting section 105, it is displayed that the parking mode is the forward parking mode and the direction to the parking area is the right of the vehicle. The turning amount of the steering wheel for selecting the forward-perpendicular right parking mode is displayed as right-one round, in which the range of the turning amount can be appropriately changed.

Further, when the driver selects parallel parking of the automatic parking modes through the parking mode switch, as shown in FIG. 3, the message window 100, the parking direction display section 101, the left steering arrow 106, and the right steering arrow 107 are displayed, respectively.

A rearward-parallel left parking mode selecting section 108 and a rearward-parallel right parking mode selecting section 109 are displayed at the left side of the parking direction display section 101.

As described above, in the rearward-parallel left parking mode selecting section 108, it is displayed that the parking mode is a parallel parking mode, and the direction to the parking area is the left of the vehicle, in which the turning amount of the steering wheel for selecting the rearward-parallel left parking mode is also displayed. The turning amount of the steering wheel shown in FIG. 3 is a left-half round as an example, and the range of the turning amount may be appropriately changed.

In the rearward-parallel right parking mode selecting section 109, it is also displayed that the parking mode is a parallel parking mode, and the direction to the parking area is the right of the vehicle, in which the turning amount of the steering wheel for selecting the rearward-parallel right parking mode is displayed. The turning amount of the steering wheel shown in FIG. 3 is a right-half round as an example.

According to the method for selecting a parking mode of the present disclosure, the driver has to select only whether it is perpendicular parking or parallel parking through the human machine interface 50 and then turn the steering wheel according to the desired parking mode with reference to the parking direction display section 101, the left steering arrow 106, and the right steering arrow 107, as shown in FIGS. 2 and 3, to select a desired parking mode. Thus, there is no need to select the parking mode by changing each mode using a switch among the rearward-perpendicular right parking mode, the rearward-perpendicular left parking mode, the rearward-parallel right parking mode, the rearward-parallel left parking mode, the forward-perpendicular right parking mode, and the forward-perpendicular left parking mode, as in the method for selecting a parking mode of the related art.

Further, regardless of whether it is perpendicular parking or parallel parking, when the direction to the parking area is the left of the vehicle, the desired parking mode is selected by turning the steering wheel left, and when the direction to the parking area is the right of the vehicle, the desired parking mode is selected by turning the steering wheel right, so that it is possible to intuitively and simply select the desired parking mode, thus improving user convenience.

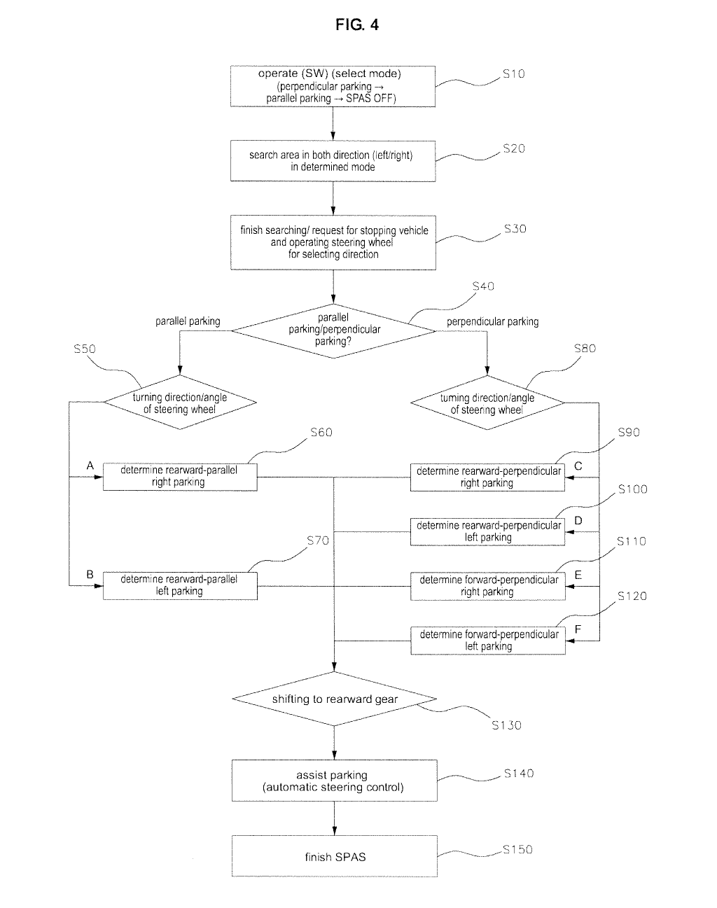

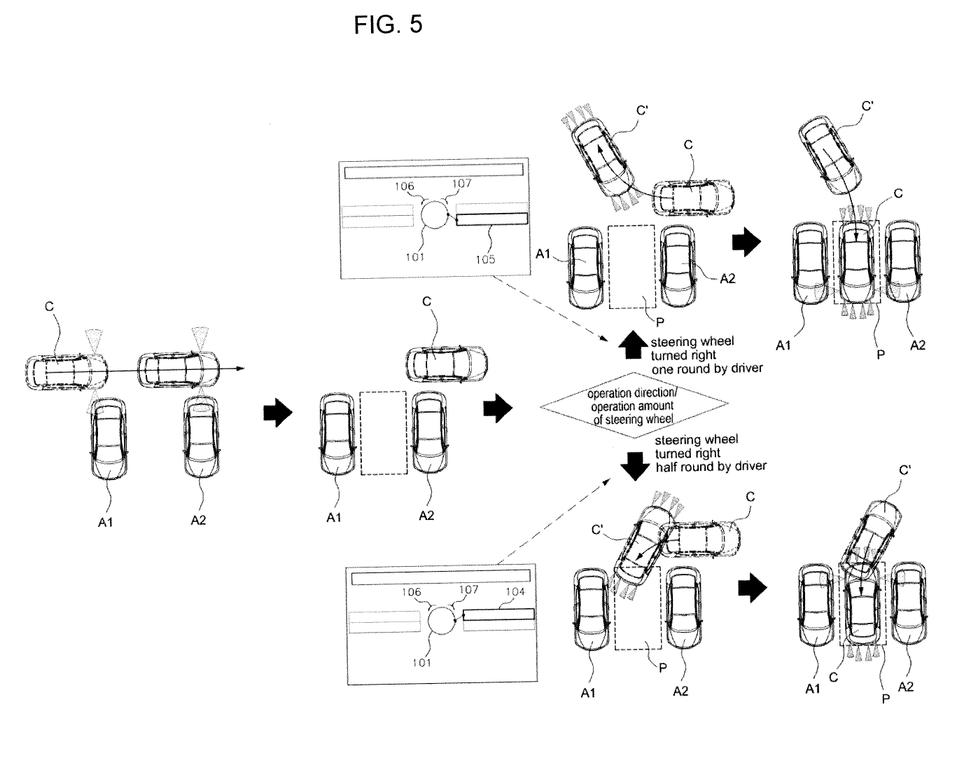

A method for selecting a parking mode of the present disclosure is described hereafter in detail with reference to FIGS. 4 and 5.

FIG. 4 is a flowchart of automatic parking according to a method for selecting an automatic parking mode of the present disclosure.

In the method for selecting an automatic parking mode of the present disclosure, a plurality of ultrasonic sensors 10b, 10c, 10d, and 10e on a front side of a car body, ultrasonic sensors 10a and 10f on left and right front sides of the car body, a plurality of ultrasonic sensors 20b, 20c, 20d, and 20e on a rear side of the car body, and ultrasonic sensors 20a and 20f on left and right rear sides of the car body, a steering angle sensor 30, a SPAS ECU 60, and a human machine interface 50 are used.

First, a user selects whether a desired parking mode is a perpendicular parking mode or a parallel parking mode by operating a parking mode switch (not shown) (S10).

When the parking mode switch is operated, automatic parking modes are displayed on the human machine interface 50 such that the user can select them, in which the interface is the same as those that are used in the methods of the related art. Here, only two parking modes, a perpendicular parking mode and the parallel parking mode, which can be selected through the parking mode switch are displayed in the present disclosure, so the user can easily select. Alternatively, it is possible to selectively turn off the automatic parking mode (“SPAS OFF” in S10) through the interface 50.

When the desired parking mode is selected, as described above, the distance from a parking area is searched by the ultrasonic sensors on the front or the rear sides of the car body while the vehicle moves to the parking area (S20), sensor signals from the ultrasonic sensors are inputted to the SPAS ECU 60, and searching for the parking area is finished. The SPAS ECU 60 stops the vehicle for parking and displays a request for selecting the parking mode according to the parallel parking or the perpendicular parking on the human machine interface 50 or outputs it as a voice through a speaker in the vehicle (S30).

The SPAS ECU 60 checks whether the automatic parking mode selected by the user (S10) is the perpendicular parking mode or the parallel parking mode (S40). If the parallel parking mode is selected, the SPAS ECU 60 displays the parking direction display section 101, the rearward-parallel left parking mode selecting section 108, and the rearward-parallel right parking mode selecting section 109 on the interface 50 and receives a turning direction and a turning angle of a steering wheel operated by a driver (S50).

When the steering wheel is turned left and the turning angle is the same as the turning amount displayed in the rearward-parallel left parking mode selecting section 108 in step S50, the SPAS ECU 60 determines that the user has selected the rearward-parallel left parking mode for the automatic parking mode (S60). Shifting a gear into reverse is performed (S130), steering control for automatic parking is performed (S140) in accordance with a general SPAS logic according to the selected rearward-parallel left parking mode, and the automatic parking is finished (S150).

Further, when the steering wheel is turned right and the turning angle is the same as the turning amount displayed in the rearward-parallel right parking mode selecting section 109 in step S50, the SPAS ECU 60 determines that the user has selected the rearward-parallel right parking mode for the automatic parking mode (S70), shifting the gear into reverse is performed (S130), the steering control for automatic parking is performed (S140) in accordance with the general SPAS logic according to the selected rearward-parallel right parking mode, and the automatic parking is finished (S150).

When the checked automatic parking mode is the perpendicular parking mode in step S40, the SPAS ECU 60 displays the parking direction display section 101, the rearward-perpendicular left parking mode selecting section 102, and the forward-perpendicular left parking mode selecting section 103 at the left of the parking direction display section 101, as shown in FIG. 2, displays the rearward-perpendicular right parking mode selecting section 104 and the forward-perpendicular right parking mode selecting section 105 at the right of the parking direction display section 101, and receives the turning direction and the turning angle of the steering wheel operated by the driver (S80).

When the steering wheel is turned right and the turning angle is the same as the turning amount displayed in the rearward-perpendicular right parking mode selecting section 104 in step S80, the SPAS ECU 60 determines that the user has selected the rearward-perpendicular right parking mode for the automatic parking mode (S90), shifting the gear into reverse is performed (S130), and the steering control for automatic parking is performed (S140) in accordance with the general SPAS logic according to the selected rearward-perpendicular right parking mode, and the automatic parking is finished (S150).

When the steering wheel is turned left and the turning angle is the same as the turning amount displayed in the rearward-perpendicular left parking mode selecting section 102 in step S80, the SPAS ECU 60 determines that the user has selected the rearward-perpendicular left parking mode for the automatic parking mode (S100), shifting the gear into reverse is performed (S130), and the steering control for automatic parking is performed (S140) in accordance with the general SPAS logic according to the selected rearward-perpendicular left parking mode, and the automatic parking is finished (S150).

Similarly, when the steering wheel is turned right and the turning angle is the same as the turning amount displayed in the forward-perpendicular right parking mode selecting section 105 in step S80, the SPAS ECU 60 determines that the user has selected the forward-perpendicular right parking mode for the automatic parking mode (S110). When the steering wheel is turned left and the turning angle is the same as the turning amount displayed in the forward-perpendicular left parking mode selecting section 103 in the step S80, the SPAS ECU 60 determines that the user has selected the forward-perpendicular left parking mode for the automatic parking mode (S120).

Thereafter, shifting the gear into reverse (S130) and steering control for the automatic parking are performed (S140) in accordance with the general SPAS logic according to the forward-perpendicular right parking mode or the forward-perpendicular left parking mode selected in step S110 or step S120, and the automatic parking is finished (S150).

FIG. 5 is a view showing a vehicle that is parked in accordance with the method for selecting an automatic parking mode of the present disclosure. In the automatic parking of a vehicle C to a parking area P between a first vehicle A1 and a second vehicle A2, when the parking area P is found, the steering wheel is turned right, and the turning amount is one round, the automatic parking mode of the forward-perpendicular right parking mode is selected, so that the vehicle C is moved rearward to a position C′ and forwardly perpendicularly parked to the parking area P.

When the steering wheel is turned right and the turning amount is a half-round, the automatic parking mode of the rearward-perpendicular right parking mode is selected, so that the vehicle C is moved rearward to a position C″ and rearwardly and perpendicularly parked to the parking area P.

Although the present disclosure was described with reference to specific embodiments shown in the drawings, it is apparent to those skilled in the art that the present disclosure may be changed and modified in various ways without departing from the scope of the present invention, which is described in the following claims.

What is claimed is:

1. A method for selecting an automatic parking mode of a vehicle, the method comprising a step of:
receiving whether an automatic parking mode is a perpendicular parking or a parallel parking,
wherein the automatic parking mode is selected by turning a steering wheel in a clockwise or counterclockwise direction according to a steering wheel angle as displayed on a human machine interface (HMI) in accordance with the received perpendicular parking or parallel parking.

2. The method of claim 1, further comprises a step of, after the step of receiving the automatic parking mode, searching for a parking area by a plurality of ultrasonic sensors in the selected parking mode.

3. The method of claim 2, further comprises steps of, after the step of searching for the parking area:
sending sensor signals to a smart parking assist system electronic control unit (SPAS ECU); and
displaying a request for selecting the automatic parking mode on the HMI after the SPAS ECU stops the vehicle.

4. The method of claim 3, further comprises a step of, after the step of displaying the request, checking, by the SPAS ECU, whether the selected automatic parking mode is the perpendicular parking or the parallel parking.

5. The method of claim 4, further comprises a step of, after the step of checking the selected automatic parking mode, if the automatic parking mode is the perpendicular parking, displaying a parking direction display section which shows a parking direction in a center of the HMI, rearward-perpendicular left parking mode selecting section and forward-perpendicular left parking mode selecting section at a left portion of the parking direction display section for a user to select, and the parking direction to the parking area and the turning amount of the steering wheel for selecting the corresponding parking mode in the parking mode selecting sections.

6. The method of claim 4, further comprises a step of, after the step of checking the selected automatic parking mode, if the automatic parking mode is the perpendicular parking, displaying a parking direction display section which shows a parking direction in a center of the HMI, a rearward-perpendicular right parking mode selecting section and a forward-perpendicular right parking mode section at a right portion of the parking direction display section for a user to select, and the parking direction to the parking area and the turning amount of the steering wheel for selecting the corresponding parking mode in the parking mode selecting sections.

7. The method of claim 4, further comprises a step of, after the step of checking the selected automatic parking mode, if the automatic parking mode is the parallel parking, displaying a parking direction display section which shows a parking direction in a center of the HMI, a rearward-parallel left parking mode selecting section and a rearward-parallel right parking mode selecting section at left and right portions of the parking direction display section, respectively for a user to select, and the parking direction of the parking area and the turning amount of the steering wheel for selecting the corresponding parking mode in the parking mode selecting sections.

8. The method of claim 1, wherein in the step of receiving the automatic parking mode, the user can selectively turn off the automatic parking mode on the HMI.

9. The method of claim 3, wherein the request for selecting the parking mode is output as a voice through a speaker in the vehicle.

10. The method of claim 2, wherein the plurality of ultrasonic sensors are provided on front and rear sides of the vehicle.

11. The method of claim 3, wherein a steering angle sensor (SAS) for monitoring a steering angle, the SPAS ECU for calculating a moving direction and the steering angle of the vehicle, and the HMI are provided in the vehicle.

12. The method of claim 5, further comprising a step of, after the step of displaying, determining, by the SPAS ECU, the automatic parking mode among a rearward-perpendicular left parking mode and a forward-perpendicular left parking mode in the perpendicular parking.

13. The method of claim 6, further comprising a step of, after the step of displaying, determining, by the SPAS ECU, the automatic parking mode among a rearward-perpendicular right parking mode and a forward-perpendicular right parking mode in the perpendicular parking.

14. The method of claim 7, further comprising a step of, after the step of displaying, determining, by the SPAS ECU, the automatic parking mode among a rearward-parallel right parking mode and a rearward-parallel left parking mode in the parallel parking.

15. The method of claim 12, further comprises steps of, after the step of determining:
shifting a gear into reverse in the selected automatic parking mode; and
performing a steering control for automatic parking in accordance with a SPAS logic.

16. The method of claim 13, further comprises steps of, after the step of determining:
shifting a gear into reverse in the selected automatic parking mode; and
performing a steering control for automatic parking in accordance with a SPAS logic.

17. The method of claim 14, further comprises steps of, after the step of determining:
shifting a gear into reverse in the selected automatic parking mode; and
performing a steering control for automatic parking in accordance with a SPAS logic.
